(19) United States
(12) Patent Application Publication
(10) Pub. No.: US 2008/0185893 A1
(43) Pub. Date: Aug. 7, 2008

(54) VEHICLE SEAT SYSTEM

(76) Inventors: Meinhard BEHRENS, Obernkirchen (DE); Klaus-Dieter Habedank, Stadthagen (DE)

Correspondence Address: KENYON & KENYON LLP, ONE BROADWAY, NEW YORK, NY, 10004, US

(21) Appl. No.: 12/024,601

(22) Filed: Feb. 1, 2008

(30) Foreign Application Priority Data
Feb. 1, 2007 (DE) 10 2007 005 143.5

(51) Int. Cl. B60N 2/02

(52) U.S. Cl. 297/378.1

(57) ABSTRACT

A vehicle seat system, e.g., for a motor vehicle, includes a vehicle seat including a seat back and a seat part. A storage space is accessible by folding away and/or displacing the seat part and is provided below the seat part. The vehicle seat system includes a folding vehicle seat capable of being folded up and situated next to the vehicle seat. In the folded state, when the seat part is folded away and/or displaced, the folding vehicle seat is capable of being, e.g., substantially in its entirety, lowered from above into the storage space and/or folded from above into the storage space.

### CROSS-REFERENCE TO RELATED APPLICATIONS

The present application claims priority to Application No. 10 2007 005 143.5, filed in the Federal Republic of Germany on Feb. 1, 2007, which is expressly incorporated herein in its entirety by reference thereto.

### FIELD OF THE INVENTION

The present invention relates to a vehicle seat system, e.g., for a motor vehicle, having a vehicle seat including a seat back and a seat part, a storage space accessible by folding away the seat part being provided below the seat part.

### BACKGROUND INFORMATION

Such a vehicle seat system is described in European Published Patent Application No. 1 449 720. European Published Patent Application No. 1 449 720 also describes a seat part situated next to the vehicle seat, which is capable of being folded into the storage space, and a seat back associated with the seat part but separate from it, which is capable of being folded away laterally.

U.S. Pat. No. 808,679 describes a folding vehicle seat capable of being folded up, which in the folded state may be slid from the side under an adjacent seat.

German Published Patent Application No. 689 03 290 describes a back seat for a motor vehicle capable of being folded over, which has a seat surface and two seat backs situated side by side, which are each equipped with a device for locking in the raised application position, both seat backs being supported by a common horizontal shaft, the latter being able to be swiveled about an axis between a raised application position of the seat bench and a folded-down position of the two seat backs and one of the seat backs being mounted on it in a swiveling manner.

German Published Patent Application No. 10 2004 011 137 describes a motor vehicle back seat system having at least one first seat component swiveling about an axis, which is lockable at least indirectly with the vehicle structure, and a swiveling second seat component situated offset in the axial direction of the axis, which is lockable with the first seat component, at least one double fitting being provided for swiveling and locking the first seat component and the second seat component.

### SUMMARY

Example embodiments of the present invention provide an improved vehicle seat system, and example embodiments of the present invention provide an improved passage to a rear, e.g., to a third, row of seats.

According to example embodiments of the present invention, a vehicle seat system, e.g., for a motor vehicle, includes a vehicle seat including a seat back and a seat part, a storage space accessible by folding away and/or displacing the seat part being provided below the seat part, and the vehicle seat system including a folding vehicle seat capable of being folded up and situated next to the vehicle seat, which in the folded state, when the seat part is folded away and or displaced, is capable of being, substantially entirely, lowered from above into the storage space and/or folded from above into the storage space.

The folding vehicle seat may include, e.g., a folding vehicle seat seat back and a folding vehicle seat seat part, there being, e.g., a provision for the folding vehicle seat seat back and the folding vehicle seat seat part to be mechanically permanently connected to each other, e.g., by a hinge. As regards the folding vehicle seat in the folded state, when the seat part is folded away, being capable of being, substantially in its entirety, lowered from above into the storage space and/or folded from above into the storage space, this, e.g., signifies that both the folding vehicle seat seat part as well as the folding vehicle seat seat back are accommodated or are capable of being accommodated in the storage space. In a folding vehicle seat capable of being folded up, for example, a folding vehicle seat seat back is foldable onto a folding vehicle seat seat part. A folding vehicle seat may be not wider than 400 mm. A folding vehicle seat may be narrower than the vehicle seat. The storage space may be substantially closed or enclosed.

The vehicle seat and the folding vehicle seat may be mechanically connected to each other by a hinge. The folding vehicle seat may include a folding vehicle seat seat back and a folding vehicle seat seat part, the folding vehicle seat seat back being height-adjustable, for example. For this purpose, a provision is made, e.g., for the height of the folding vehicle seat seat back to be reduced such that it may be accommodated in the storage space. A folding vehicle seat seat back may not be height-adjustable because it may include a height-adjustable head rest. The folding vehicle seat seat back may be capable of sliding into itself and/or capable of being folded up. The folding vehicle seat seat back may have an at least bipartite construction, at least two parts of the folding vehicle seat seat back, including in each case at least one back panel, being mechanically connected to each other by a hinge. Suitable refinements for the height adjustment of the folding vehicle seat seat back may be gathered from the subsequently described exemplary embodiments or from German Published Patent Application No. 36 04 187, German Published Patent Application No. 101 44 078, German Published Patent Application No. 27 06 097 and/or German Published Patent Application No. 37 04 489, each of which is expressly incorporated herein in its entirety by reference thereto.

The seat back may include a split back panel extending substantially across the entire seat back. A back panel may be a sheet metal or panel for maintaining a survival space in a motor vehicle and/or for passenger protection. A back panel may extend substantially across the entire seat back, e.g., when it extends substantially across the entire seat back in two orthogonal directions. A back panel may extend substantially across the entire seat back, e.g., when it extends substantially across the entire seat back in the transverse direction of the motor vehicle and in the vertical direction. A back panel may extend substantially across the entire seat back, e.g., when it extends substantially across the entire seat back in its longitudinal and in the vertical direction.

The folding vehicle seat seat back may be lockable on the seat back.

According to example embodiments of the present invention, a motor vehicle includes a vehicle seat system—e.g., including one or more of the aforementioned features—the vehicle seat and the folding vehicle seat being mechanically connected to each other, e.g., by a hinge having an axis of rotation extending substantially in the longitudinal direction of the motor vehicle.

The folding vehicle seat seat back may have an at least bipartite construction, at least two parts of the folding vehicle seat seat back, including in each case at least one back panel, being mechanically connected to each other by a hinge having an axis of rotation extending substantially in the transverse direction of the motor vehicle.

The seat part and the seat back may be mechanically connected to each other by a hinge having a seat back axis of rotation extending substantially in the transverse direction of the motor vehicle.

The folding vehicle seat seat part and the folding vehicle seat seat back may be mechanically connected to each other by a hinge having an axis of rotation extending substantially in the transverse direction of the motor vehicle, which with respect to the axis of rotation of the seat back is offset or displaceable (forward) in the longitudinal direction of the vehicle. With respect to the axis of rotation of the seat back, the axis of rotation may be offset or displaceable (forward) by at least 50 mm in the longitudinal direction of the motor vehicle.

At least one rear bench or another vehicle seat may be situated behind the vehicle seat system, the folding vehicle seat clearing an access to the rear bench or to the additional vehicle seat when it is situated in the storage space. A vehicle seat for a driver and/or a vehicle seat for a front passenger may be situated in front of the vehicle seat system. The folding vehicle seat may be situated on a drive tunnel.

According to example embodiments of the present invention, a method is for operating a vehicle seat system—e.g., including one or more of the aforementioned features—or for operating a motor vehicle including a vehicle seat system—e.g., including one or more of the aforementioned features—for example, the vehicle seat system including a vehicle seat including a seat back and a seat part, a storage space being provided below the seat part, a folding vehicle seat situated next to the vehicle seat being folded up, the seat part being folded away and/or displaced for clearing an access to the storage space, and the folding vehicle seat being, substantially in its entirety, lowered from above into the storage space (e.g., through the access) and/or folded from above into the storage space from above (e.g., through the access).

A lock between the vehicle seat and a folding vehicle seat seat back of the folding vehicle seat may be released prior to folding up the folding vehicle seat. The height of the folding vehicle seat seat back may be reduced prior to folding up the folding vehicle seat.

According to example embodiments of the present invention, a method for operating a vehicle seat system—e.g., including one or more of the aforementioned features—or for operating a motor vehicle including a vehicle seat system—e.g., including one or more of the aforementioned features—for example, the vehicle seat system including a vehicle seat including a seat back and a seat part, a storage space being provided below the seat part, in which a folded-up folding vehicle seat is situated, the seat part being folded away and/or displaced for clearing an access to the storage space, the folding vehicle seat being taken out of the storage space through the access, and the folding vehicle seat being unfolded and being, e.g., locked next to the vehicle seat.

The height of a folding vehicle seat seat back may be increased after taking the folding vehicle seat out of the storage space. The seat back of the folding vehicle seat may be subsequently locked on the vehicle seat.

A motor vehicle may be a land vehicle that may be used individually in road traffic. Motor vehicles, however, are not limited to land vehicles having an internal combustion engine.

Further features and aspects of example embodiments of the present invention are described in more detail below with reference to the appended Figures.

### BRIEF DESCRIPTION OF THE DRAWINGS

FIG. 1 schematically illustrates a an example embodiment of a motor vehicle.

FIG. 2 is a perspective view of a vehicle seat system, according to an example embodiment of the present invention, having a folding vehicle seat in an unfolded state.

FIG. 3 is a perspective view of the vehicle seat system illustrated in FIG. 2 in another state.

FIG. 4 is a perspective view of the vehicle seat system illustrated in FIG. 2 in another state.

FIG. 5 is a perspective view of the vehicle seat system illustrated in FIG. 2 in another state.

FIG. 6 is a perspective view of the vehicle seat system illustrated in FIG. 2 in another state.

FIG. 7 is a perspective view of the vehicle seat system illustrated in FIG. 2 in another state.

FIG. 8 is a perspective view of the vehicle seat system illustrated in FIG. 2 in another state.

FIG. 9 is a perspective view of the vehicle seat system illustrated in FIG. 2 in another state.

FIG. 10 illustrates a method for operating a vehicle seat system such as that illustrated in FIG. 2 or a motor vehicle such as that illustrated in FIG. 1.

FIG. 11 is a perspective view of the vehicle seat system illustrated in FIG. 2 without upholstery.

FIG. 12 is a side view of the vehicle seat system illustrated in FIG. 2 without upholstery.

FIG. 13 is a side view of the vehicle seat system illustrated in FIG. 2 without upholstery.

FIG. 14 is a perspective view of the vehicle seat system illustrated in FIG. 2 without upholstery.

FIG. 15 illustrates a clamping mechanism for clamping a lock.

FIG. 16 illustrates the clamping mechanism illustrated in FIG. 15 having a clamped lock.

FIG. 17 is a side view of an unfolded folding vehicle seat having a bipartite seat back.

FIG. 18 is a side view of the folding vehicle seat illustrated in FIG. 17.

FIG. 19 is a side view of the folding vehicle seat illustrated in FIG. 17 in a folded state.

### DETAILED DESCRIPTION

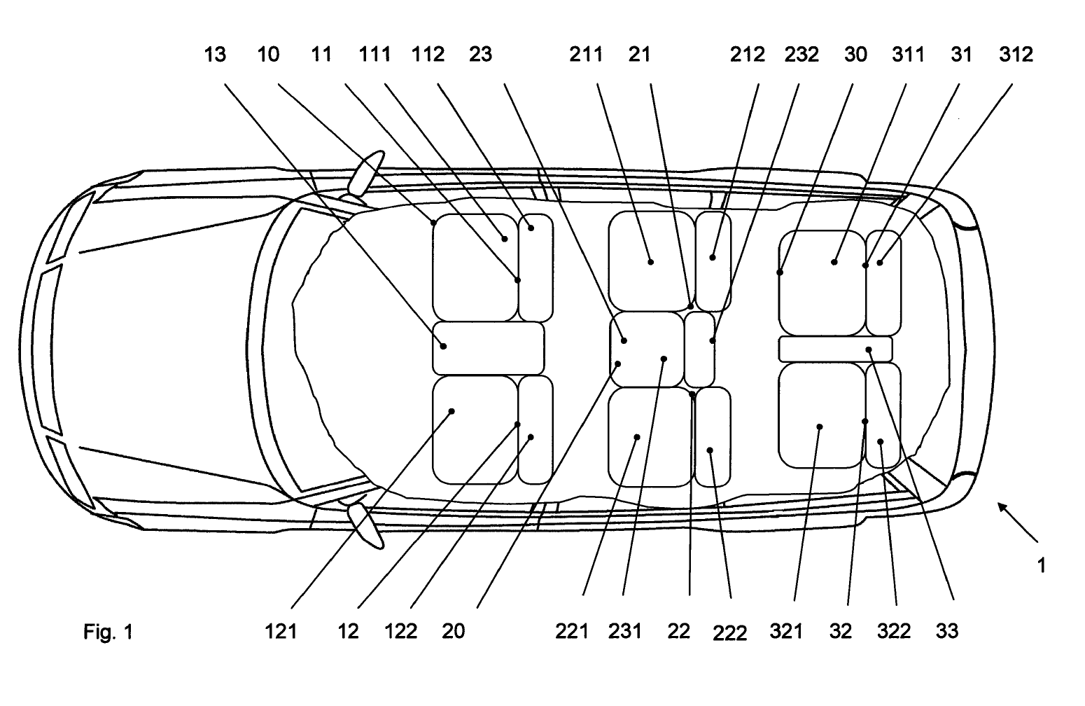

FIG. 1 is a schematic top view of an exemplary embodiment of a motor vehicle 1. Motor vehicle 1 includes a front vehicle seat system 10 having a vehicle seat 11, a console 13 and a vehicle seat 12, a middle vehicle seat system 20 and a rear vehicle seat system 30 having a vehicle seat 31, a console 33 and a vehicle seat 32. Vehicle seat system 20 includes a vehicle seat 21, a vehicle seat 22, and a folding vehicle seat 23 situated between vehicle seat 21 and vehicle seat 22, which in the present exemplary embodiment is situated on a drive tunnel. Reference numerals 111, 121, 211, 221, 311 and 321 denote seat parts of vehicle seats 11, 12, 21, 22, 31 and 32, and reference numerals 112, 122, 212, 222, 312 and 322 denote seat backs of vehicle seats 11, 12, 21, 22, 31 and 32.

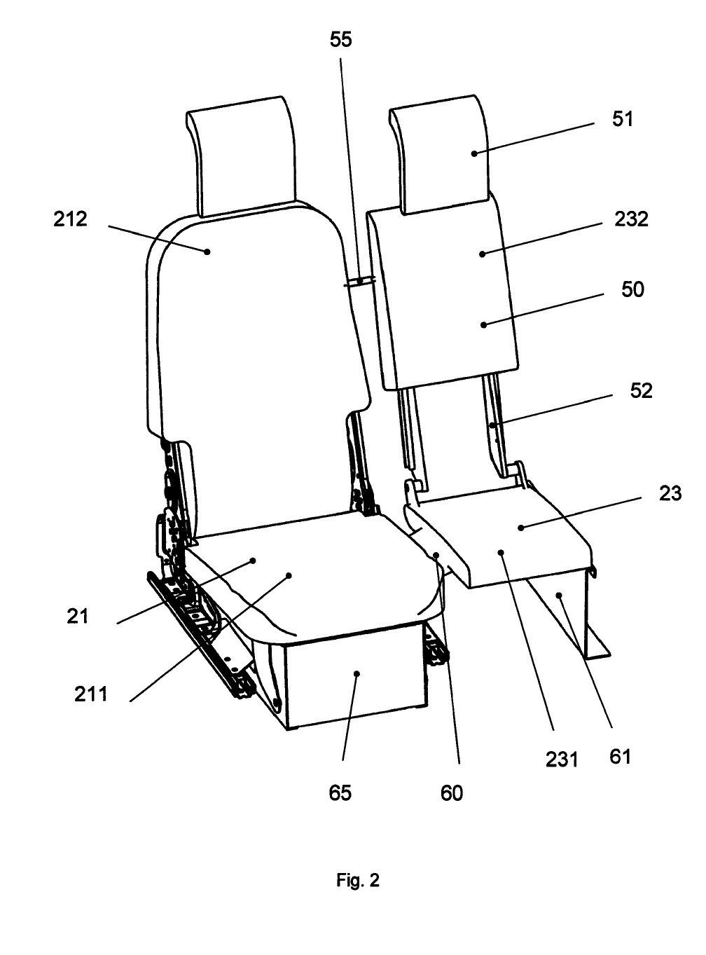

Folding vehicle seat 23, which is illustrated in more detail in FIG. 2, includes a folding vehicle seat seat part 231 and a folding vehicle seat seat back 232. Folding vehicle seat seat back 232 includes an upholstered part 50 displaceable along a rail 52 and a height-adjustable head rest 51. Another upholstered part (having a back panel) may be provided in the space between upholstered part 50 and folding vehicle seat seat part 231. Folding vehicle seat seat part 231 is mechanically connected to vehicle seat 21 by a hinge 60 having an axis of rotation extending substantially in the longitudinal direction of motor vehicle 1. On a side across from hinge 60, folding vehicle seat 23 has a support section 61 assigned to it for supporting folding vehicle seat seat part 231. A storage space 65 is provided under folding vehicle seat seat part 231. Folding vehicle seat back 232 is fastened in detachable fashion on seat back 212 by a lock 55.

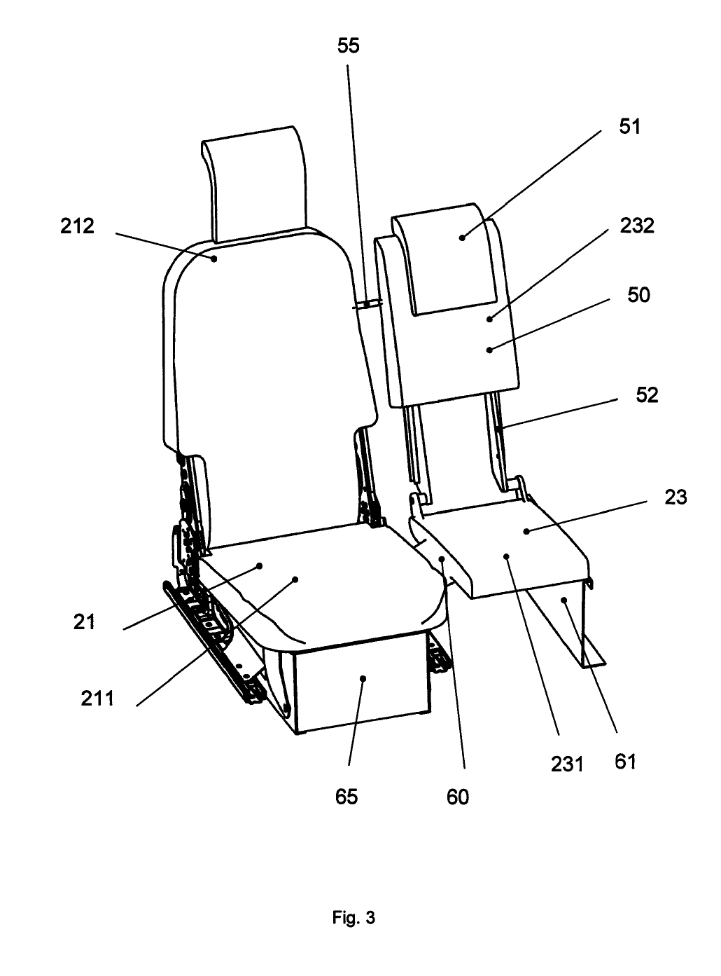

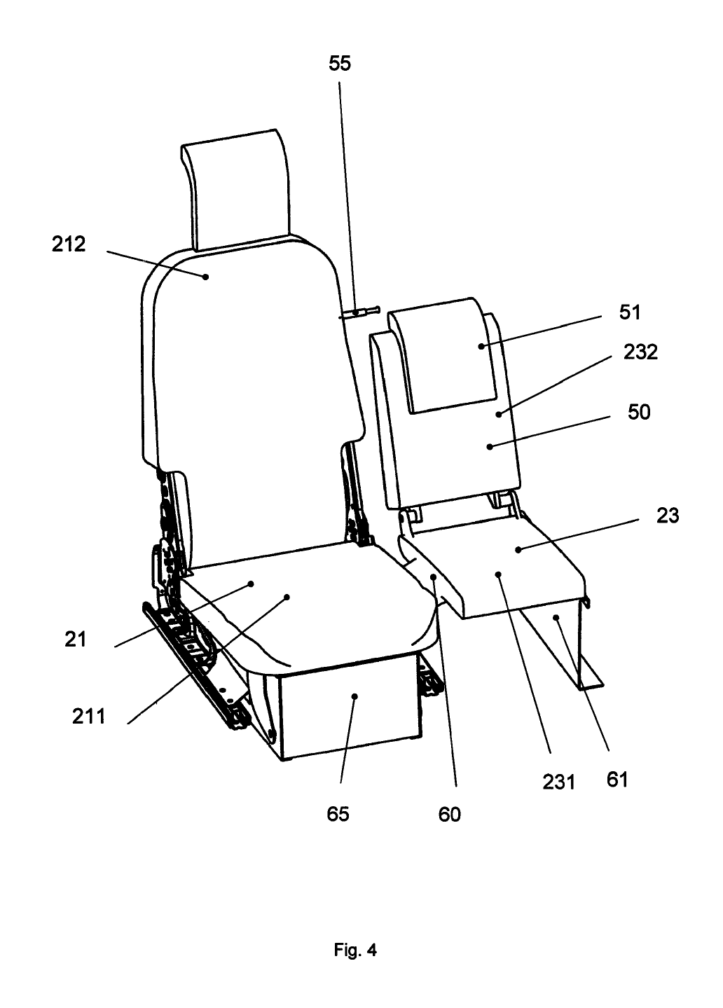

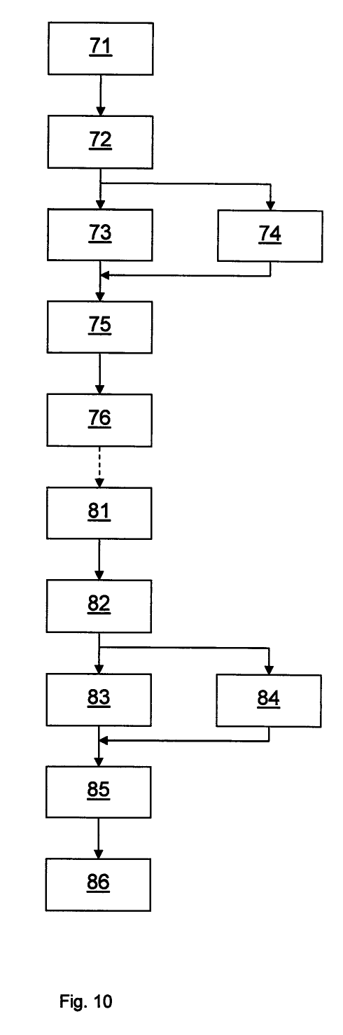

FIG. 10 illustrates a method described with reference to FIGS. 3 to 8 for operating vehicle seat system 20. For this purpose, in a step 71, height-adjustable head rest 51 is slid against upholstered part 50, as illustrated in FIG. 3. In addition, lock 55 is released. This is followed by a step 72, in which the height of folding vehicle seat seat back 232 is reduced by sliding together folding vehicle seat seat back 232, as illustrated in FIG. 4. For the purpose of providing a child seat, there may be a provision for locking folding vehicle seat seat back 232 in this position as well, for example on seat back 212, and for folding vehicle seat 23 to be equipped with a safety belt suitable for children. In this connection, e.g., there may be a provision for lock 55 to be situated so low that it is possible to lock folding vehicle seat seat back 232 in the state illustrated in FIG. 4 using the lower lock 55.

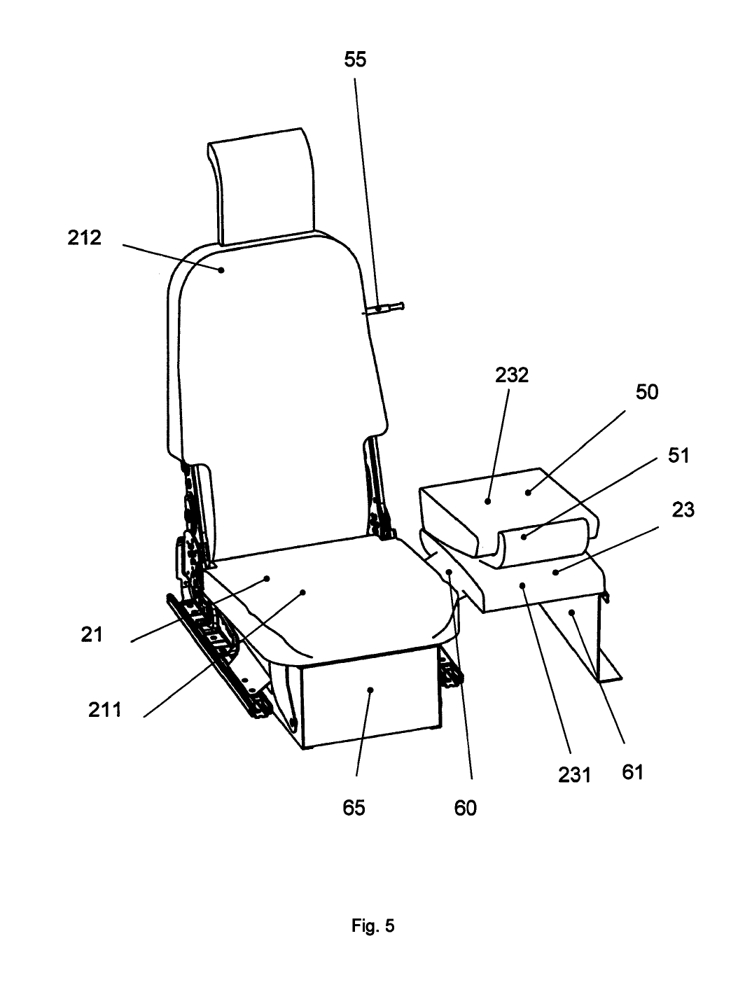

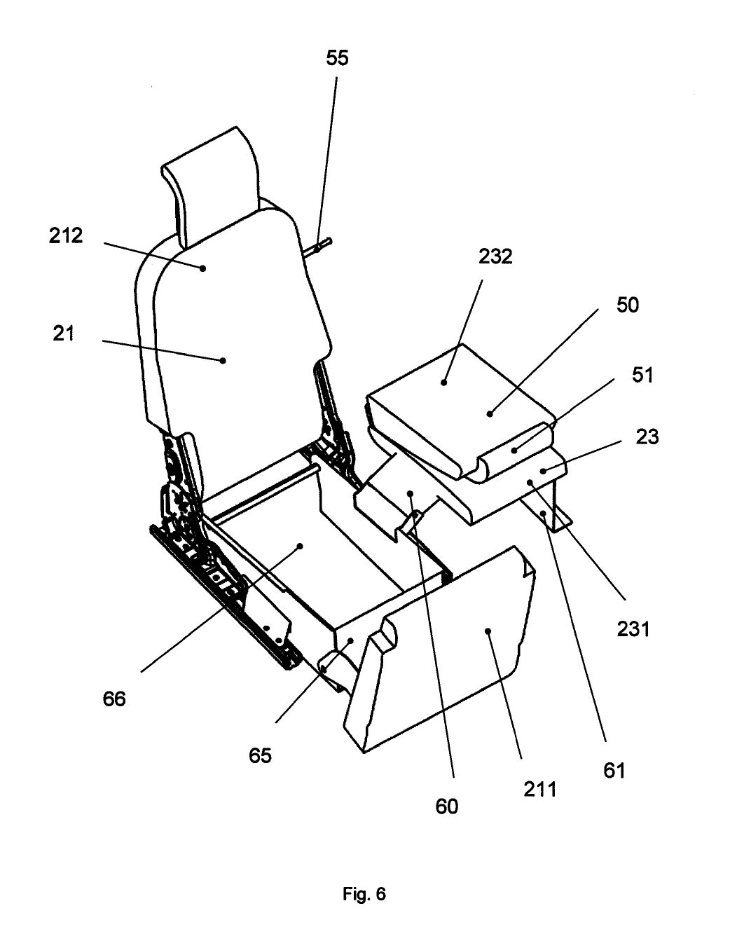

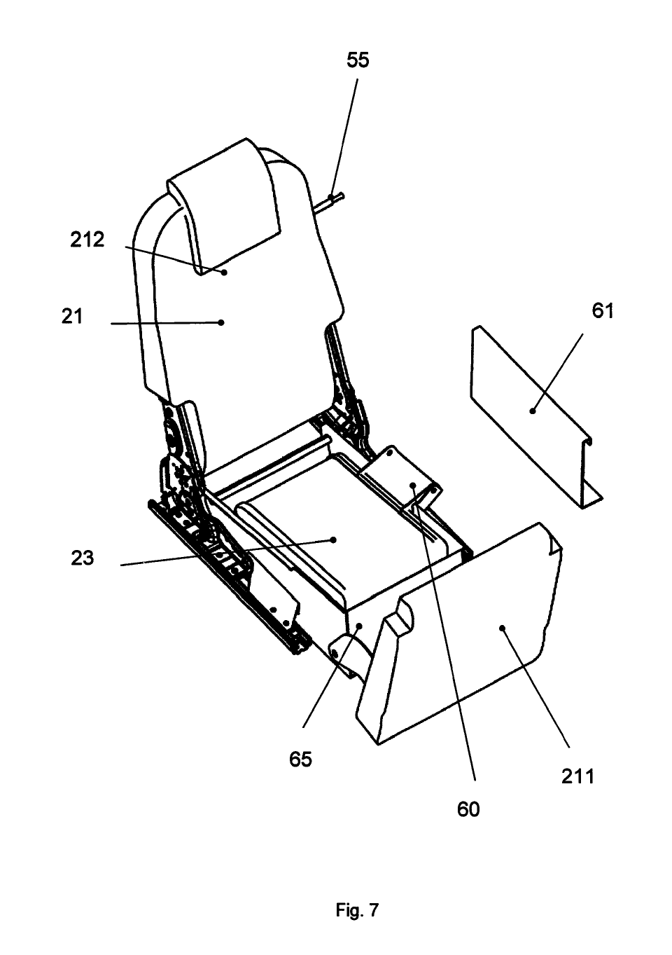

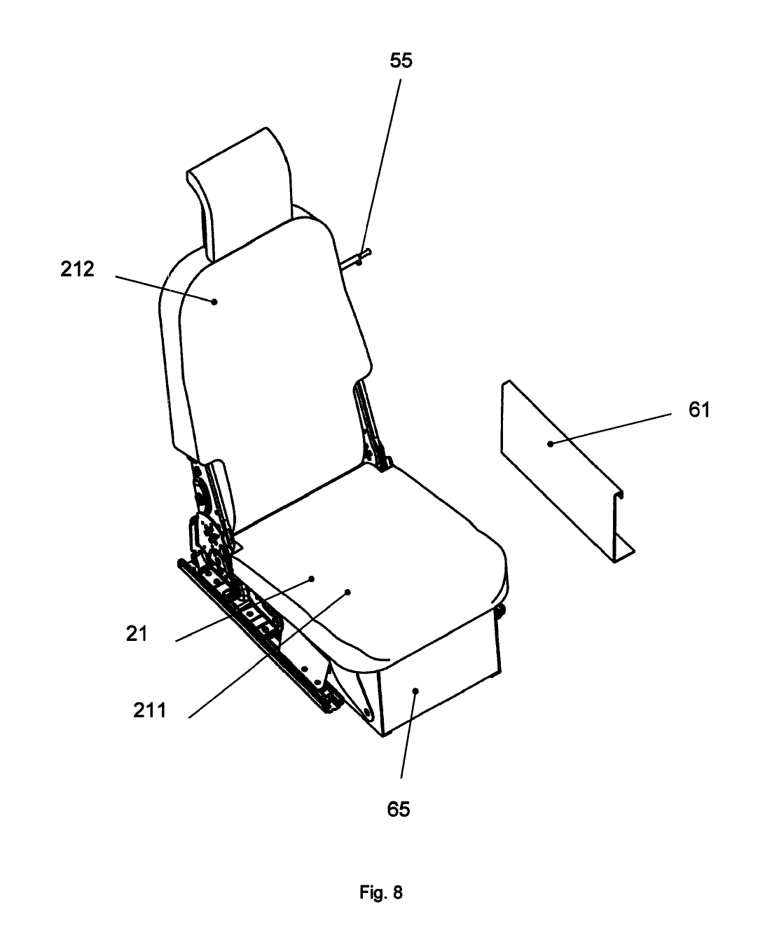

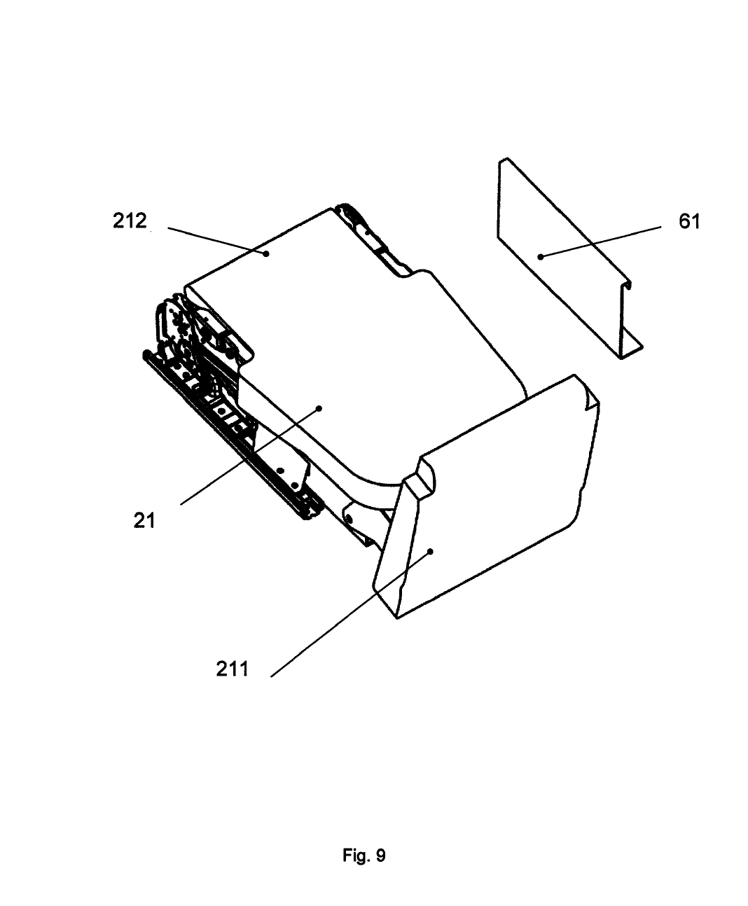

Step 72 is followed by a step 73, in which folding vehicle seat 23 is folded up, as illustrated in FIG. 5, and by a step 74, in which seat part 211 is folded away or displaced for clearing an access 66 to storage space 65, as illustrated in FIG. 6. This is followed by a step 75, in which folding vehicle seat 23, as illustrated in FIG. 7, in its entirety is lowered from above into storage space 65 and/or folded from above into storage space 65. Subsequently, seat part 211 is folded back for closing storage space 65 in a step 76, as illustrated in FIG. 8. In addition, lock 55 may be folded away or sunk into seat back 212. In the state illustrated in FIG. 8, the gap between vehicle seat 21 and vehicle seat 22 or the support section allows access to vehicle seats 31 and 33 of motor vehicle 1. As illustrated in FIG. 9, there may be a provision for seat back 212 to be folded over for enlarging a loading area starting from the state illustrated in FIG. 7.

To make folding vehicle seat 23 available—beginning from the state illustrated in FIG. 8—seat part 211 is folded away or displaced in a step 81 for clearing access 66 to storage space 65, as illustrated in FIG. 7. Subsequently, in a step 82, folding vehicle seat 23 is taken out of storage space 65 through access 66 or is folded out of storage space 65, as illustrated in FIG. 6.

Step 82 is followed by a step 84, in which seat part 211, as illustrated in FIG. 5, is folded back so as to close storage space 65, and by a step 83, in which folding vehicle seat 23 is unfolded, as illustrated in FIG. 4. Subsequently, as illustrated in FIG. 3, upholstered part 50 is slid out in a step 85, and folding vehicle seat seat back 232 is locked on seat back 212 in a step 86. In addition, head rest 51 is positioned, as illustrated in FIG. 2.

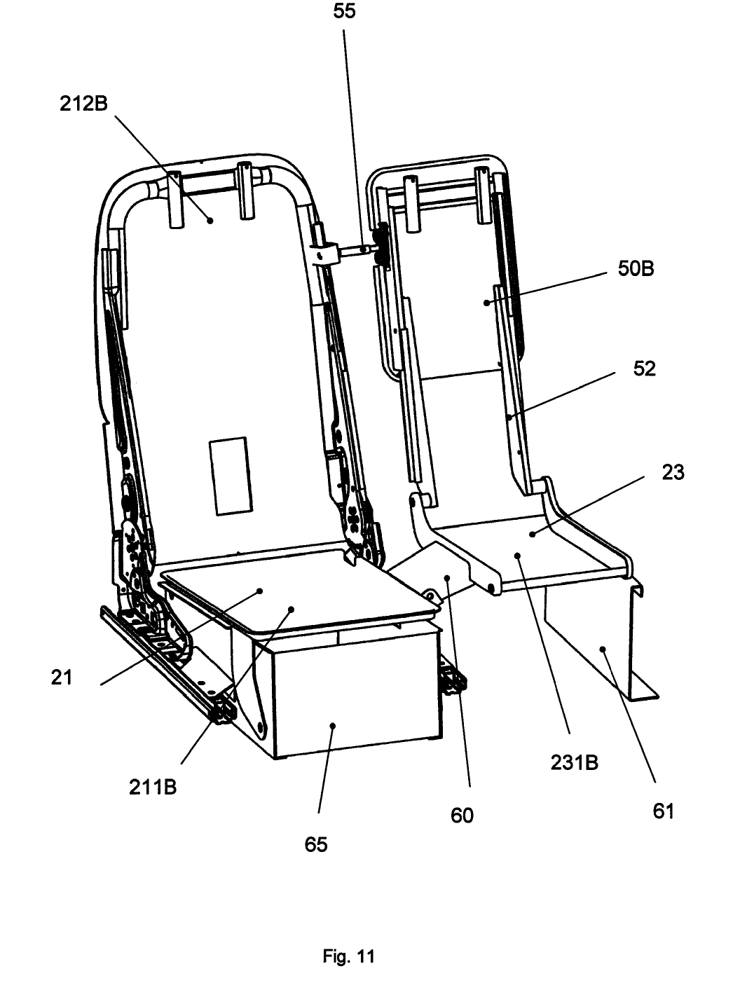

FIGS. 11 to 16 illustrate vehicle seat system 20 (without vehicle seat 22) without upholstery, FIG. 11 showing vehicle seat system 20 (without vehicle seat 22) in a perspective front view. Reference numeral 211B denotes a support sheet metal of seat part 211, reference numeral 212B denotes a back panel of seat back 212, reference numeral 231B denotes a support sheet metal of folding vehicle seat seat part 231, and reference numeral 50B denotes a support sheet metal of upholstered part 50.

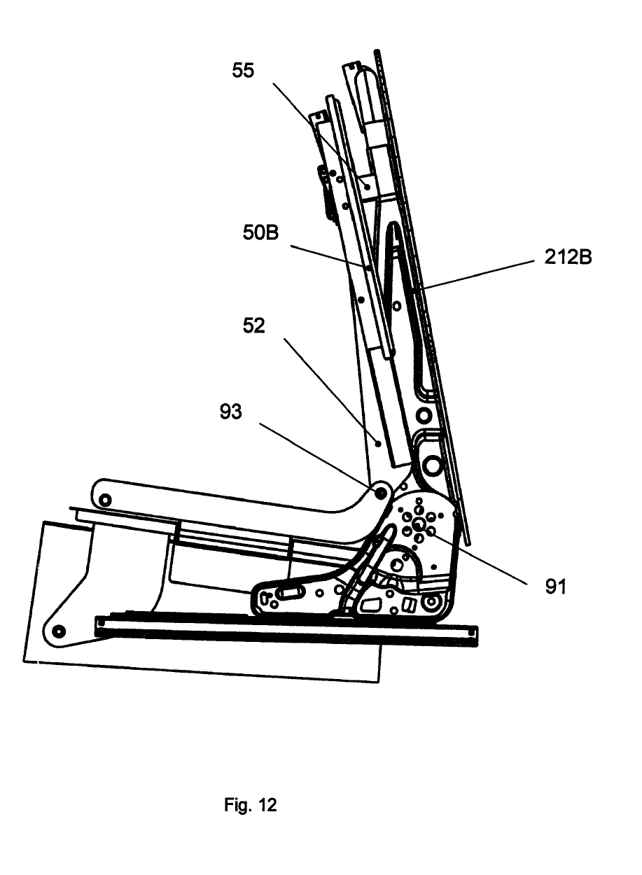

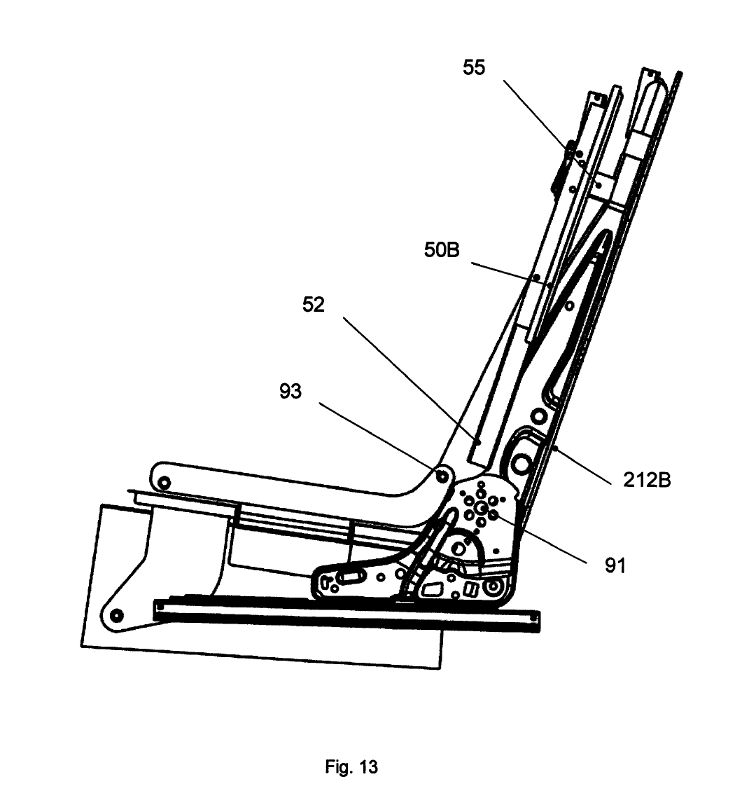

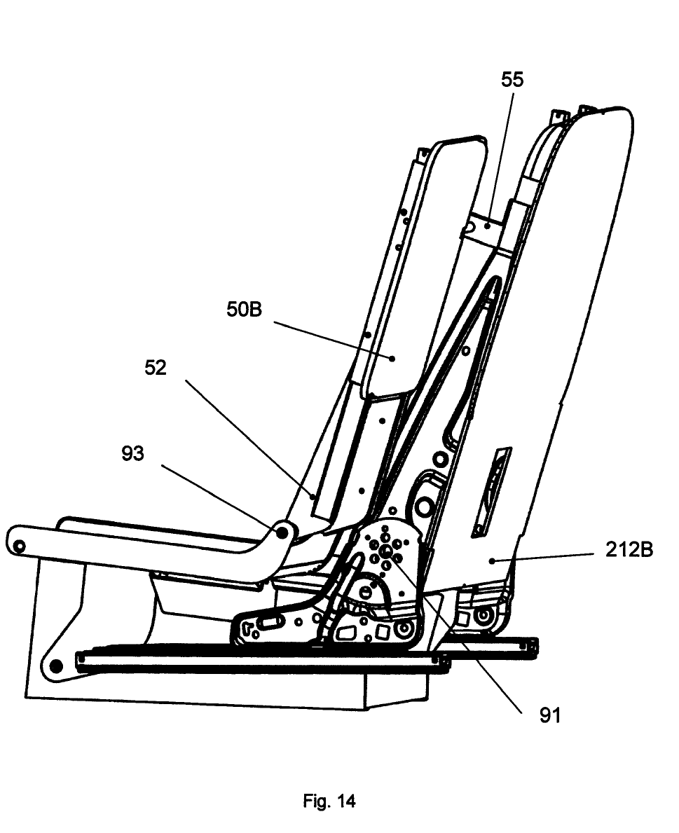

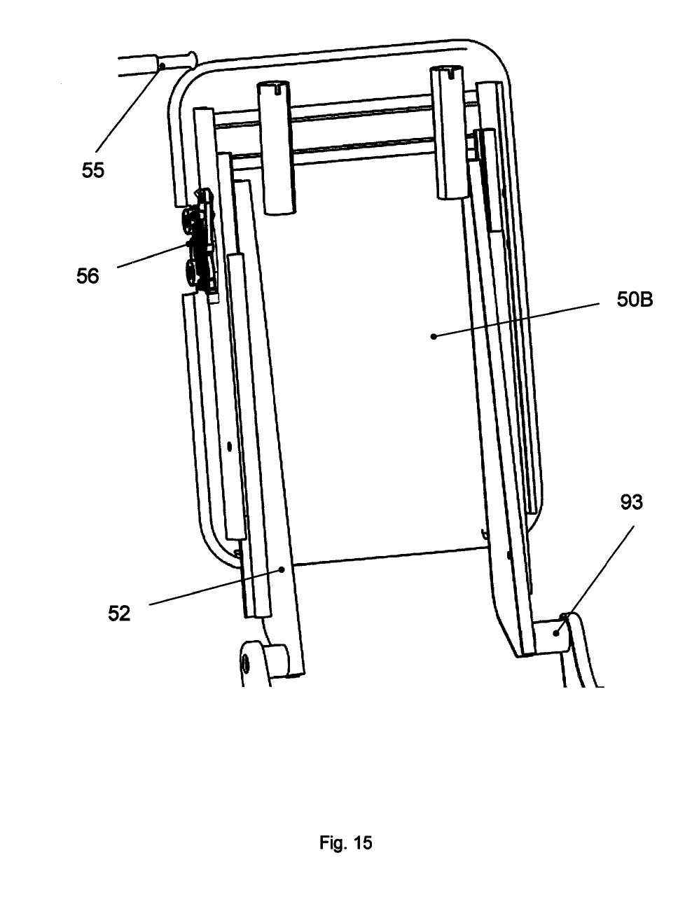

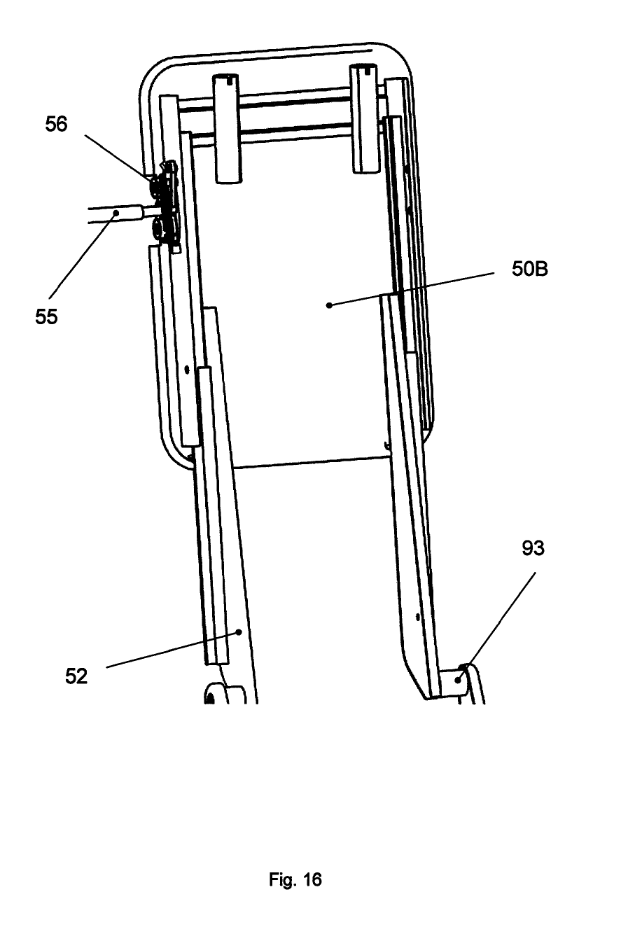

FIGS. 12 and 13 are side views of vehicle seat system 20 (without vehicle seat 22), and FIG. 14 is a side view of vehicle seat system 20 (without vehicle seat 22). Reference numeral 91 denotes a hinge having an axis of rotation extending substantially in the transverse direction of motor vehicle 1 for mechanically connecting seat part 211 and seat back 212. Reference numeral 93 denotes a hinge having an axis of rotation extending substantially in the transverse direction of motor vehicle 1 for mechanically connecting folding vehicle seat seat part 231 and folding vehicle seat seat back 232, the axis of rotation of hinge 93 being offset or displaceable (forward) with respect to the axis of rotation of hinge 91 in the longitudinal direction of motor vehicle 1, e.g., by at least 50 mm. The axis of rotation of hinge 91 is an exemplary embodiment of a seat back axis of rotation. FIGS. 15 and 16 illustrate a clamping mechanism 56 for clamping lock 55 and thus for locking folding vehicle seat seat back 232 on seat back 231.

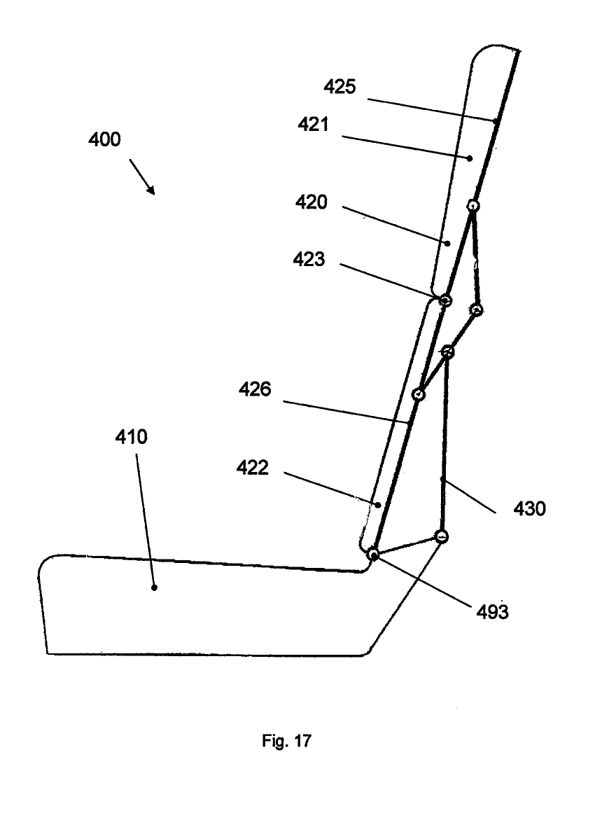

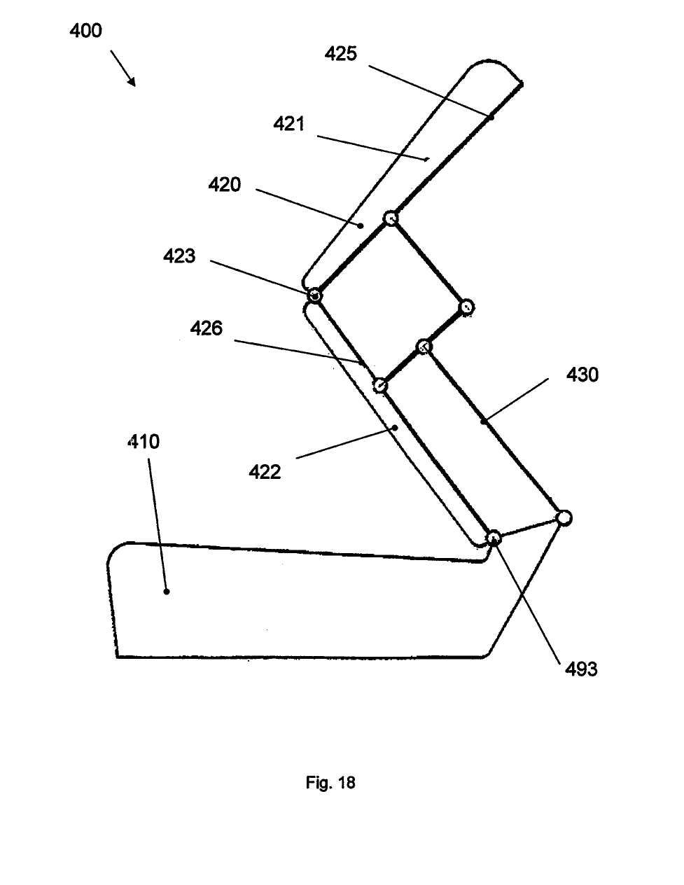

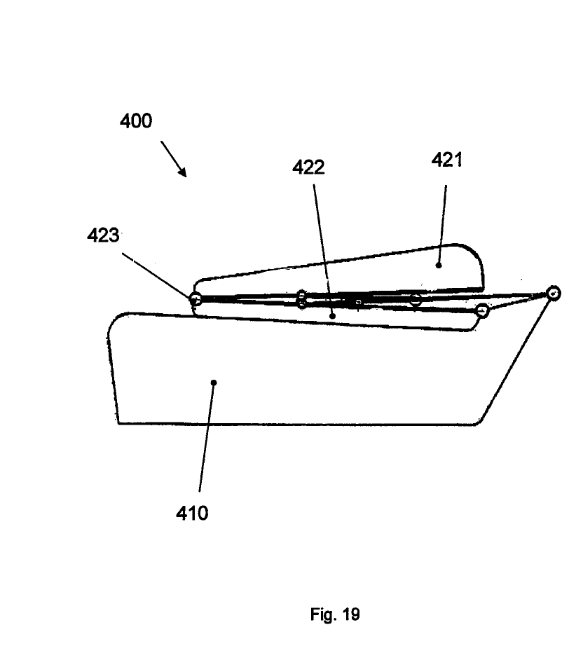

FIGS. 17 to 19 illustrate a folding vehicle seat 400 for an alternative use of folding vehicle seat 23, folding vehicle seat 400 being represented as unfolded in FIG. 17 and folded up in FIG. 19. Folding vehicle seat 400 includes a folding vehicle seat seat part 410 and a folding vehicle seat seat back 420, which is mechanically connected to folding vehicle seat seat part 410 by a hinge 493 having an axis of rotation extending substantially in the transverse direction of motor vehicle 1. Folding vehicle seat seat back 420 is foldable in itself and includes an upper seat back part 421 having a back panel 425, a lower seat back part 422 having a back panel 426 and a foldable support mechanism 430. Upper seat back part 421 is mechanically connected to lower seat back part 422 by a hinge 423 having an axis of rotation extending substantially in transverse direction of motor vehicle 1. Upper seat back part 421 and lower seat back part 422 are exemplary embodiments of parts of a folding vehicle seat seat back. Parts of a folding vehicle seat seat back include, e.g., those parts that make a direct (e.g., by touch) contribution toward supporting an occupant.

The components in the Figures are illustrated with simplicity and clarity in mind and not necessarily to an exact scale. Thus, for example, the orders of magnitude of some components are exaggerated as compared to other components in order to facilitate understanding of the exemplary embodiments.

### LIST OF REFERENCE NUMERALS

1 motor vehicle
10, 20, 30 vehicle seat system
11, 12, 21, 22, 31, 32 vehicle seat
13, 33 console
23, 400 folding vehicle seat
50 upholstered part
50B support sheet metal for an upholstered part
51 head rest
52 rail
55 lock
56 clamping mechanism
60, 91, 93, 423, 493 hinge
61 support section
65 storage space
66 access to a storage space
71, 72, 73, 74, 75, 76, 81, 82, 83, 84, 85, 86 step
111, 121, 211, 221, 311, 321 seat part
112, 122, 212, 222, 312, 322 seat back
211B support sheet metal for a seat part
212B, 425, 426 back panel
231, 410 folding vehicle seat seat part
231B support sheet metal for a folding vehicle seat seat part
232, 420 folding vehicle seat seat back
421 upper seat back part
422 lower seat back part
430 foldable support mechanism

What is claimed is:

1. A vehicle seat system, comprising:
a vehicle seat including a seat back and a seat part;
a storage space provided below the seat part and accessible by at least one of (a) folding away and (b) displacing the seat part; and
a folding vehicle seat arranged next to the vehicle seat and foldable up;
wherein, in a folded state, when the seat part is at least one of (a) folded away and (b) displaced, the folding vehicle seat substantially entirely at least one of (a) lowerable from above into the storage space and foldable from above into the storage space.

2. The vehicle seat system according to claim 1, wherein the vehicle seat system is arranged as a vehicle seat system for a motor vehicle.

3. The vehicle seat system according to claim 1, wherein the vehicle seat and the folding vehicle seat are mechanically connected to each other by a hinge.

4. The vehicle seat system according to claim 1, wherein the folding vehicle seat includes a folding vehicle seat seat back and a folding vehicle seat seat part.

5. The vehicle seat system according to claim 4, wherein the folding vehicle seat seat back is height-adjustable.

6. The vehicle seat system according to claim 5, wherein the folding vehicle seat seat back is slidable into itself.

7. The vehicle seat system according to claim 5, wherein the folding vehicle seat seat back is foldable up.

8. The vehicle seat system according to claim 7, wherein the folding vehicle seat seat back includes an at least bipartite construction, each of at least two parts of the folding vehicle seat seat back including at least one back panel mechanically connected to each other by a hinge.

9. The vehicle seat system according to claim 4, wherein the folding vehicle seat seat back lockable on the seat back.

10. A motor vehicle, comprising:
a vehicle seat system including:
a vehicle seat including a seat back and a seat part;
a storage space provided below the seat part and accessible by at least one of (a) folding away and (b) displacing the seat part; and
a folding vehicle seat arranged next to the vehicle seat and foldable up;
wherein, in a folded state, when the seat part is at least one of (a) folded away and (b) displaced, the folding vehicle seat substantially entirely at least one of (a) lowerable from above into the storage space and foldable from above into the storage space.

11. The motor vehicle according to claim 10, wherein the vehicle seat and the folding vehicle seat are mechanically connected to each other by a hinge having an axis of rotation extending substantially in a longitudinal direction of the motor vehicle.

12. The motor vehicle according to claim 10, wherein a folding vehicle seat seat back has an at least bipartite construction, each of at least two parts of the folding vehicle seat seat back including at least one back panel mechanically connected to each other by a hinge having an axis of rotation extending substantially in a transverse direction of the motor vehicle.

13. The motor vehicle according to claim 10, wherein a seat part and the seat back are mechanically connected to each other by a hinge having a seat back axis of rotation extending substantially in a transverse direction of the motor vehicle.

14. The motor vehicle according to claim 13, wherein a folding vehicle seat seat part and a folding vehicle seat seat back are mechanically connected to each other by a hinge having an axis of rotation extending substantially in the transverse direction of the motor vehicle, the axis of rotation at least one of (a) offset and (b) displaceable in a longitudinal direction of the motor vehicle with respect to the seat back axis of rotation.

15. The motor vehicle according to claim 14, wherein the axis of rotation is at least one of (a) offset and (b) displaceable by at least 50 mm in the longitudinal direction of the motor vehicle with respect to the seat back axis of rotation.

16. A method for operating a vehicle seat system including a vehicle seat including a seat back and a seat part, a storage space provided below the seat part, and a folding vehicle seat arranged next to the vehicle seat, comprising:
folding up the folding seat;
at least one of (a) folding away and (b) displacing the seat part to clear an access to the storage space; and
at least one of (a) lowering from above into the storage space and (b) folding from above into the storage space the folding vehicle seat substantially in its entirety.

17. The method according to claim 16, further comprising releasing a lock between the vehicle seat and a folding vehicle seat seat back of the folding vehicle seat prior to the folding up of the folding vehicle seat.

18. The method according to claim 16, further comprising reducing a height of a folding vehicle seat seat back prior to the folding up of the folding vehicle seat.

19. A method for operating a motor vehicle including a vehicle seat system, the vehicle seat system including a vehicle seat including a seat back and a seat part, a storage space provided below the seat part, and a folding vehicle seat arranged next to the vehicle seat, comprising:
folding up the folding seat;
at least one of (a) folding away and (b) displacing the seat part to clear an access to the storage space; and
at least one of (a) lowering from above into the storage space and (b) folding from above into the storage space the folding vehicle seat substantially in its entirety.

20. A method for operating a vehicle seat system including a vehicle seat including a seat back and a seat part, a storage space provided below the seat part, and a folding vehicle seat arranged in the storage space, comprising:
at least one of (a) folding away and (b) displacing the seat part to clear an access to the storage space;
taking the folding vehicle seat out of the storage space through the access; and
unfolding the folding vehicle seat.

21. The method according to claim 20, further comprising increasing a height of a folding vehicle seat seat back after the taking out of the folding vehicle seat from the storage space.

22. The method according to claim 20, wherein further comprising locking a seat back of the folding vehicle seat on the vehicle seat after the unfolding of the folding vehicle seat.

23. A method for operating a motor vehicle including a vehicle seat system, the vehicle seat system including a vehicle seat including a seat back and a seat part, a storage space provided below the seat part, and a folding vehicle seat arranged in the storage space, comprising:
at least one of (a) folding away and (b) displacing the seat part to clear an access to the storage space;
taking the folding vehicle seat out of the storage space through the access; and
unfolding the folding vehicle seat.
